(19) United States
(12) Patent Application Publication
(10) Pub. No.: US 2005/0007335 A1
(43) Pub. Date: Jan. 13, 2005

(54) Driving circuit for flat display

(75) Inventor: Yao Wen Chu, Kweishan (TW)

Correspondence Address: Richard P. Berg, Esq.;Ladas & Parry, Suite 2100, 5670 Wilshire Boulevard, Los Angeles, CA, 90036, US

(73) Assignee: BENQ CORPORATION

(21) Appl. No.: 10/888,100

(22) Filed: Jul. 9, 2004

(30) Foreign Application Priority Data
Jul. 11, 2003 (TW) 092119047

(51) Int. Cl. G09G 3/36

(52) U.S. Cl. 345/102

(57) ABSTRACT

The present invention is a driving circuit for a flat display. The flat display comprises a panel and at least two light tubes as a backlight source of the panel. The driving circuit comprises two transformers. Each transformer has a primary side and a secondary side. The primary sides of the two transformers are connected to a resonance circuit. The secondary side of each transformer is connected to a corresponding light tube for illumination. The windings on the primary sides of the two transformers are the same, and the windings on the secondary sides of the two transformers are different from each other by reversing the winding on the secondary side of one of the two transformers.

### BACKGROUND OF THE INVENTION

1. Field of the Invention

The present invention relates to a driving circuit for a flat display, especially to a driving circuit of a backlight source for a liquid crystal display (LCD).

2. Description of the Prior Art

The ordinary flat display, such as an LCD, comprises a liquid crystal panel, a backlight source, and a driving circuit. The driving circuit is used for driving the backlight source to illuminate the liquid crystal panel.

Please refer to FIG. 1. FIG. 1 is a schematic diagram of a driving circuit 10 for an LCD of the prior art. The driving circuit 10 is used for driving a backlight source, and the circuit has two cold cathode fluorescent light tubes 18. The driving circuit 10 comprises a resonance circuit 12, two power-on circuits 14, and two transformers 16. The two transformers 16 are arranged and driven in a push-pull configuration. Each transformer 16 has a primary side and a secondary side. The resonance circuit 12 provides three windings at each primary side, and those are first winding 20, second winding 22, and third winding 24 respectively. Each power-on circuit 14 provides a fourth winding 26 at the corresponding secondary side. One end of each power-on circuit 14 is connected to a corresponding cold cathode fluorescent light tube 18, and the other end is grounding. The resonance circuit 12 is used for providing appropriate and stable current to the windings of the each primary side and outputting a power-on voltage from the fourth winding 26 of each secondary side via coupling of each transformer 16. The power-on voltage is used for illuminating the corresponding cold cathode fluorescent light tube 18. In the driving circuit 10, all windings of the two transformers 16 are the same.

Please refer to FIG. 2. FIG. 2 is a driving waveform diagram of the secondary sides of the two transformers 16 shown in FIG. 1. As shown in FIG. 2, L1 and L2 are the driving waveforms generated from the secondary sides of the two transformers 16 of the driving circuit 10, and L is a synthesized wave of L1 and L2. In the driving circuit 10 of the prior art, because the current is provided to the windings of the primary sides of both transformers 16, the secondary sides of the two transformers 16 generate two driving waves L1 and L2 of the same frequency, phase difference, and amplitude. After synthesizing, the enlarged synthesized wave L is generated. Because the driving wave is harmful to health and disturbs electrical signals, relative factories are devoted to research on how to reduce the driving waves.

Please refer to FIG. 3. FIG. 3 is a schematic diagram of another driving circuit 28 of the prior art. U.S. Pat. No. 6,515,427 provides a driving circuit 28. For the push-pull driving transformer, the driving circuit 28 changes the second winding 22 on the primary side of the transformer 16 of the driving circuit 10 by reversing the second winding 30 on the primary side of one of the two transformers 16. The driving circuit 28 enables the frequency and amplitude of two driving waves generated by the primary sides of the two transformers 16 to be the same, but the phase difference of the waveform is kept in 180 degree. After coupling to enlarge the voltage, the two driving waves generated by the secondary sides cancel out each other.

However, by exploring the driving circuit 28 in detail, the phase difference may be changed, thus not achieving 180 degree after coupling by the two transformers 16. Therefore, after coupling to enlarge the voltage, the two driving waves will not cancel out each other. It is enough if the objective is to reduce disturbance on the screen. However, if the objective is to reduce the radiation of the low frequency electric field, then this improvement is a lot less significant.

### SUMMARY OF THE INVENTION

The objective of the present invention is to provide a driving circuit for a liquid crystal display (LCD) to solve the problems of the prior art.

The present invention provides a driving circuit for a flat display. The flat display comprises a panel and at least two light tubes as a backlight source of the panel. The driving circuit of the present invention comprises two transformers. Each transformer has a primary side and a secondary side. The primary sides of the transformers are connected to a resonance circuit. The secondary side of each transformer is connected to a corresponding light tube for illumination. The windings on the primary sides of the two transformers are the same, but the windings on the secondary sides of the two transformers are different from each other by reversing the winding on the secondary side of one of the two transformers.

The driving circuit of the present invention reverses the winding on the secondary side of one of the two transformers and controls the phase of driving waves with the windings on the two secondary sides, so that the frequency and amplitude of the driving waves generated by the secondary sides of the two transformers are the same, but the mutual phase difference is kept in 180 degree. Therefore, the driving waveforms generated by the secondary sides of the two transformers cancel out each other to reduce the radiation of the low frequency electric field. The driving circuit of the present invention does not comprise other electromagnetic cover material, so as to reduce most of the disturbance of the driving waves. Furthermore, the driving circuit of the present invention does not only use one resonance circuit and the circuit structure of the push-pull arrangement.

The advantage and spirit of the invention may be understood by the following recitations together with the appended drawings.

### BRIEF DESCRIPTION OF THE APPENDED DRAWINGS

FIG. 1 is a schematic diagram of a driving circuit for an LCD of the prior art.

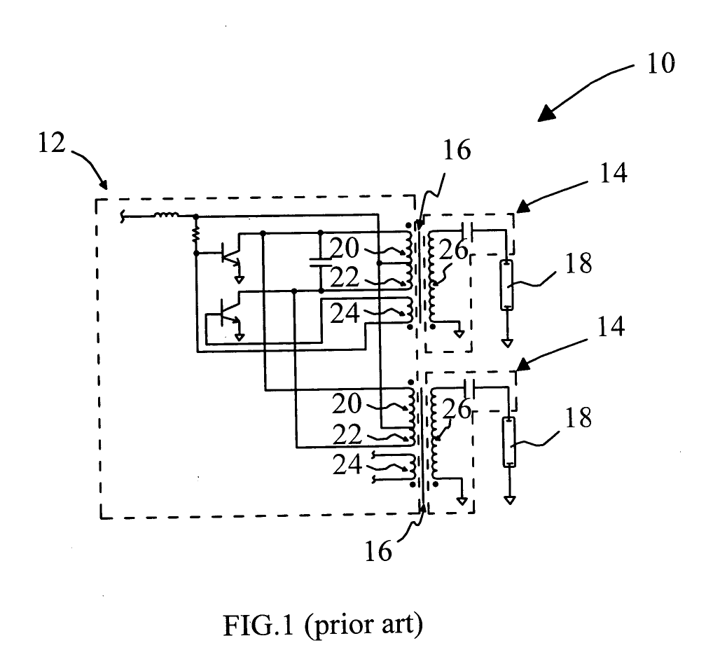

FIG. 2 is a driving waveform diagram of the secondary sides of the two transformers shown in FIG. 1.

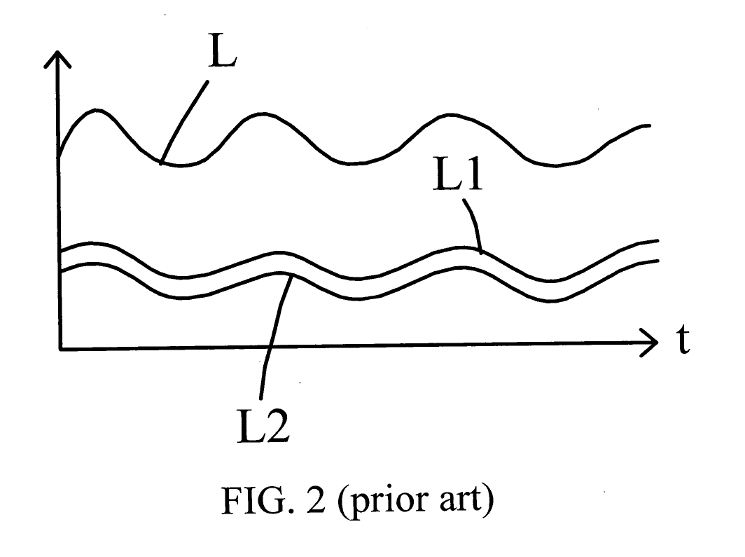

FIG. 3 is a schematic diagram of another driving circuit of the prior art.

FIG. 4 is a schematic diagram of a driving circuit of the first embodiment according to the present invention.

FIG. 5 is a driving waveform diagram of the secondary sides of the transformers of the driving circuit 40 shown in FIG. 4.

FIG. 6 is a schematic diagram of a driving circuit of the second embodiment according to the present invention.

### DETAILED DESCRIPTION OF THE INVENTION

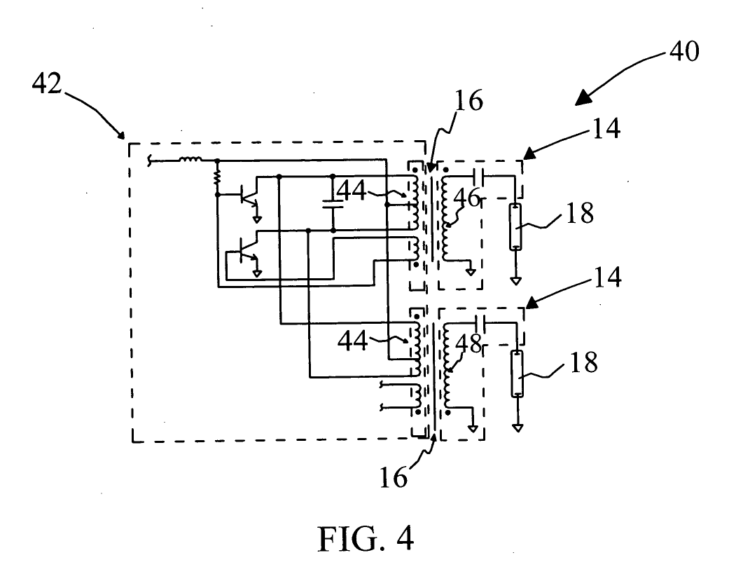

Please refer to FIG. 4. FIG. 4 is a schematic diagram of a driving circuit 40 of the first embodiment according to the present invention. The driving circuit 40 is set in an LCD. The LCD comprises a liquid crystal panel (not shown in FIG.) and two light tubes. The two light tubes may be cold cathode fluorescent light tubes 18 for a backlight source of the liquid crystal panel.

The driving circuit 40 comprises a resonance circuit 42, two power-on circuit 14, and two transformers 16. The two transformers 16 have the same driving manner, such as all push-pull or all full-bridge, and the embodiment takes the push-pull driving manner as an example. Each transformer 16 has a primary side and a secondary side. The primary side of the transformer 16 is connected to the resonance circuit 42. The resonance circuit 42 provides one winding 44 on each primary side, and the secondary sides of each transformer 16 are connected to a light tube 18 respectively.

Two power-on circuits 14 provide two windings at the corresponding secondary sides of the transformers 16. Wherein a winding 46 is reversed, the other winding 48 is not reversed. One end of each power-on circuit 14 is connected to a corresponding light tube 18, and the other end is grounding.

The resonance circuit 42 provides appropriate and stable current to the winding 44 of the primary side of each transformer 16 and outputs a power-on voltage from the windings 46 and 48 of the secondary side of each transformer 16 via coupling of each transformer 16. The power-on voltage is used for illuminating the corresponding light tubes 18.

The two windings 44 on the primary sides of the two transformers 16 are the same. The winding on the secondary side of one of the two transformers 16 is reversed, and the phase of driving waves are controlled with the windings on the two secondary sides, so that the frequency and amplitude of the driving waves generated by the secondary sides of the two transformers 16 are the same, but the mutual phase difference is kept in 180 degree.

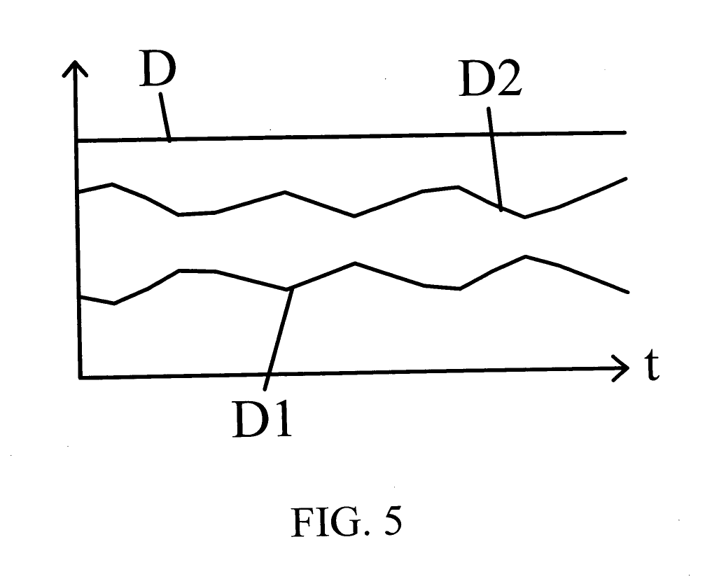

Please refer to FIG. 4 and FIG. 5. FIG. 5 is a driving waveform diagram of the secondary sides of the transformers 16 of the driving circuit 40 shown in FIG. 4. The driving waveforms of the driving circuit 40 of the present invention are shown in FIG. 5. D1 and D2 are the driving waveforms generated from the secondary sides of the two transformers 16 of the driving circuit 40, and D is a synthesized wave of D1 and D2. As shown in FIG. 5, the two driving waveforms generated from the secondary sides of the two transformers 16 cancel out each other, according to the present invention. The driving circuit of the present invention does not utilize other electromagnetic cover material but utilizes two driving waveforms, having the same frequency but opposite phase, to cancel out each other and reduce the radiation of the low frequency electric field.

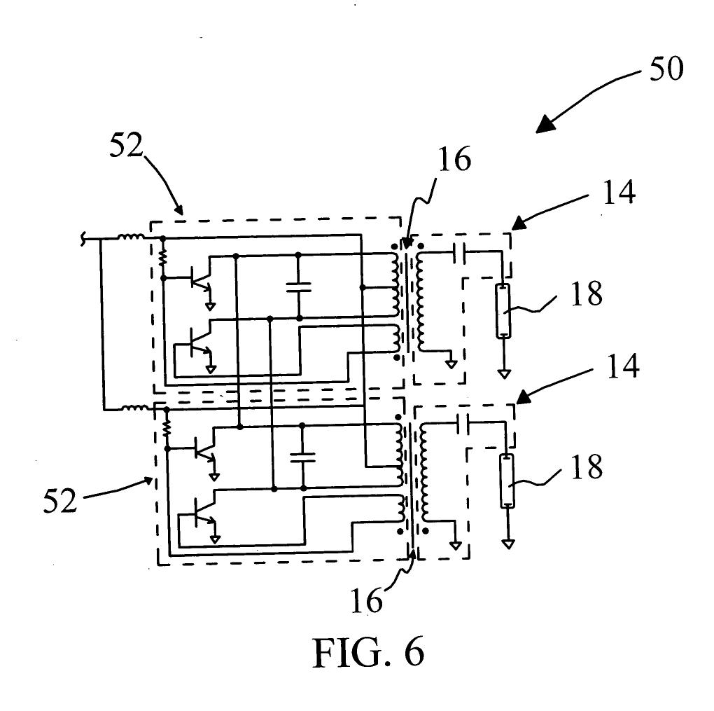

Please refer to FIG. 6. FIG. 6 is a schematic diagram of a driving circuit of the second embodiment according to the present invention. The present invention can also be applied to a set of resonance circuits for only providing current to the primary side of one transformer. In the second embodiment, the driving circuit 50 comprises two resonance circuits 52, two power-on circuits 14, and two transformers 16. The two transformers 16 utilize the same driving manner. The major difference between the driving circuit 50 of the second embodiment and the driving circuit 40 of the first embodiment is the resonance circuit, and the other disposal and driving manner are similar. Each resonance circuit 52 of the driving circuit 50 is only corresponded to one of the two transformers 16, which is different from the resonance circuit 42 of the driving circuit 40 corresponding to both transformers 16 directly in the first embodiment.

In the driving circuit of the present invention, each transformer corresponds to not only one light tube, and the kinds of light tubes are not limited to cold cathode fluorescent light tube. Moreover, as the number of light tube connected to each power-on circuit 14 is the same, each power-on circuit 14 can connect to a plurality of light tubes with parallel connection. The application of the present invention is not limited to the push-pull circuit structure, and the same driving manner of the two transformers is also permitted.

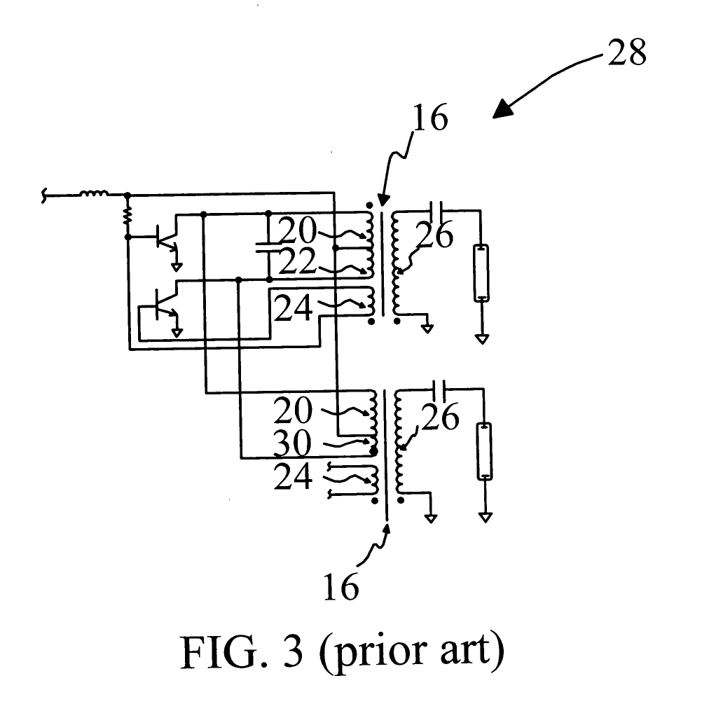

Comparing with the driving circuit 28 of the prior art (shown in FIG. 3), wherein the current is provided to the two primary sides by the same resonance circuit, the driving circuit 28 is only suitable for the push-pull circuit structure, so there are some limits in the application of the driving circuit 28 of the prior art. The driving circuits 40 and 50 of the present invention do not only use one resonance circuit and the push-pull circuit structure.

Furthermore, according to the experiment, the driving circuit 28 of the prior art cannot overcome the phase difference generated after coupling of the two transformers 16, and the radiation of the low frequency electric field is about 1.5V/m. Comparing with the driving circuit 28 of the prior art, the driving circuit of the present invention enables the two driving waveforms, having the same frequency but opposite phase, to canceled out each other, thus reducing the radiation of the low frequency electric field. Even if no other electromagnetic cover material is utilized, the reading data of the radiation of the low frequency electric field measured in the driving circuit of the present invention is reduced to 0.8V/m˜0.3V/m.

The driving circuits 40 and 50 of the present invention reverse the winding on the secondary side of one of the two transformers 16 and control the phase of driving waves with the windings on two secondary sides, so that the frequency and amplitude of the driving waves generated by the secondary sides of the two transformers 16 are the same, but the mutual phase difference is kept in 180 degree. Therefore, the driving waveforms generated by the secondary sides of the two transformers 16, which have the same frequency and opposite phase, cancel out each other to reduce the radiation of the low frequency electric field. The driving circuit of the present invention does not comprise other electromagnetic cover material, so as to reduce most of the disturbance of driving waves.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A driving circuit for a flat display, the flat display comprising a panel and at least two light tubes as a backlight source of the panel, the driving circuit comprising two transformers, each transformer having a primary side and a secondary side, the secondary side of each transformer being connected to a corresponding light tube for illumination, wherein the windings on the primary sides of the two transformers are the same, and the windings on the secondary sides of the two transformers are different from each other by reversing the winding on the secondary side of one of the two transformers.

2. The driving circuit of claim 1, wherein the windings on the secondary side of the two transformers are different from each other by reversing the winding on the secondary side of one of the two transformers, so that the frequencies of the driving waveforms generated by the secondary sides of the two transformers are the same, but the mutual phase difference is kept in 180 degree.

3. The driving circuit of claim 2, wherein the two transformers are operated in the same driving manner.

4. The driving circuit of claim 3, wherein the reading data of radiation measurement in low frequency electric field is between 0.8V/m˜0.3V/m.

5. The driving circuit of claim 1, wherein the secondary sides of the two transformers generate two driving waveforms having the same frequency but opposite phase, and the driving waveforms cancel out each other to reduce the radiation of the low frequency electric field.

6. The driving circuit of claim 1, wherein the light tube is a cold cathode fluorescent light tube (CCFL).

7. The driving circuit of claim 1, wherein the primary sides of the two transformers are connected to a resonance circuit.

8. The driving circuit of claim 1, wherein the primary side of each transformer is connected to a corresponding resonance circuit respectively.
